(19) United States
(12) Patent Application Publication
(10) Pub. No.: US 2026/0139457 A1
(43) Pub. Date: May 21, 2026

(54) WORK VEHICLE

(71) Applicant: Kubota Corporation, Osaka (JP)

(72) Inventors: Ryo WATAYA, Sakai-shi (JP); Natsumi WADA, Sakai-shi (JP); Yusuke SHOJI, Sakai-shi (JP)

(21) Appl. No.: 19/386,574

(22) Filed: Nov. 12, 2025

(30) Foreign Application Priority Data
Nov. 18, 2024 (JP) 2024-200435

(51) Int. Cl. E02F 9/26; E02F 9/20; G06F 3/02; G06F 3/0362

(52) U.S. Cl. CPC E02F 9/26; E02F 9/2004; G06F 3/02; G06F 3/0362

(57) ABSTRACT

A work vehicle operates an implement by a drive source and includes a manual controller including a push button to receive a pressing operation, and a controller configured or programmed to determine a predetermined value from among a plurality of default values that are preset, in which the predetermined value is any one of a rotation speed of the drive source, a hydraulic pressure of the implement, and a vehicle speed of the work vehicle. The controller is configured or programmed to cause a display device to sequentially display one of the plurality of default values according to a number of times that the pressing operation was performed.

### CROSS REFERENCE TO RELATED APPLICATIONS

This application claims the benefit of priority to Japanese Patent Application No. 2024-200435 filed on Nov. 18, 2024. The entire contents of this application are hereby incorporated herein by reference.

### BACKGROUND OF THE INVENTION

### 1. Field of the Invention

The present disclosure relates to work vehicles.

### 2. Description of the Related Art

A technique for adjusting the rotation speed of an engine in a work vehicle is known. For example, Japanese Laid-Open Patent Publication No. 2022-26000 discloses a technique of adjusting the rotation speed of the engine and performing an operation corresponding to a screen displayed on a display device with one dial to receive a rotation operation and a pressing operation.

Specifically, first, an engine operation function is assigned to the dial in response to a key switch that starts the engine being turned on. In this state, a user rotates the dial to adjust the rotation speed of the engine.

Next, the screen operation function is assigned to the dial according to the operation of the assignment change switch. When a user rotates the dial in this state, a cursor displayed on the display device moves on a plurality of item selection units. Then, the selection of the item selection unit is determined when the user performs a pressing operation on the dial.

As described above, in the technique of Japanese Laid-Open Patent Publication No. 2022-26000, one dial is commonly used for both the rotation operation for adjusting the engine rotation speed and the rotation operation for selecting an item. The technique of Japanese Laid-Open Patent Publication No. 2022-26000 thus suppresses an increase in the number of components of the operation device.

### SUMMARY OF THE INVENTION

In the technique of Japanese Laid-Open Patent Publication No. 2022-26000, a rotation operation of a dial is required in order to select an engine rotation speed and various items. For example, in a case where the value desired to be set by a user is a value far from the current selection item, there is a possibility that, for example, the dial needs to be rotated many times, so that the operation may become troublesome for the user.

Therefore, example embodiments of the present invention provide work vehicles in each of which a value can be selected by a simpler operation.

A work vehicle according to an example embodiment of the present disclosure is a work vehicle that operates an implement by a drive source, the work vehicle including a manual controller including a push button to receive a pressing operation, and a controller configured or programmed to determine a predetermined value from among a plurality of default values that are preset, in which the predetermined value is any one of a rotation speed of the drive source, a hydraulic pressure of the implement, and a vehicle speed of the work vehicle, and the controller is configured or programmed to cause a display device to sequentially display one of the plurality of default values according to a number of times that the pressing operation was performed.

According to example embodiments of the present disclosure, in the work vehicles, a value can be selected by a simpler operation.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a block diagram illustrating a functional configuration of a work vehicle according to an example embodiment of the present invention.

FIG. 2 is a schematic diagram illustrating a manual controller.

FIG. 3 is an example of a home screen displayed on a display device.

FIG. 4 is an example of a setting screen according to a comparative example.

FIG. 5 is a flowchart illustrating processing performed by an operation device.

FIGS. 6A to 6D are schematic diagrams illustrating how setting screens are sequentially displayed on the display device.

FIGS. 7A to 7C are schematic diagrams illustrating a state in which a default value is adjusted according to a rotation operation.

FIGS. 8A to 8D are schematic diagrams illustrating a state in which a predetermined value is determined to be a default value.

### DETAILED DESCRIPTION OF THE EXAMPLE EMBODIMENTS

Example embodiments of the present disclosure include the following configurations.

(1) A work vehicle according to an example embodiment of the present disclosure is a work vehicle that operates an implement by a drive source, the work vehicle including a manual controller including a push button to receive a pressing operation, and a controller configured or programmed to determine a predetermined value from among a plurality of default values that are preset, in which the predetermined value is any one of a rotation speed of the drive source, a hydraulic pressure of the implement, and a vehicle speed of the work vehicle, and the controller is configured or programmed to cause a display device to sequentially display one of the plurality of default values according to a number of times that the pressing operation is performed.

According to a work vehicle of an example embodiment of the present disclosure, since a user can sequentially display the default values on the display device only by performing the pressing operation without combining the rotating operation and the pressing operation, and thus the predetermined value can be set by a simpler operation. In addition, since one default value is displayed on the display device, a user can easily grasp the default value currently being selected. As a result, the user's operation can be easier.

(2) In the work vehicle according to (1), the controller may be configured or programmed to determine the predetermined value to be the default value being displayed on the display device in a case where after the pressing operation is performed, the pressing operation is not performed again until a predetermined waiting time elapses, and cause the display device to display a default value to be displayed next among the plurality of default values in a case where after the pressing operation is performed, the pressing operation is performed again before the waiting time elapses.

With this configuration, the predetermined value can be determined to be a default value being displayed by “leaving” the manual controller 3 without performing the pressing operation on it during the waiting time. As a result, the button used to select and determine the default value as the predetermined value can be limited to one push button, and the user's operation can be made easier.

(3) In the work vehicle according to (2), after the pressing operation is performed, the controller may be configured or programmed to cause the display device to display at least one of an elapsed time from when the pressing operation is performed to current time or a remaining time from the current time to time when the waiting time elapses.

By viewing at least one of the elapsed time and the remaining time, a user can grasp how long he or she needs to leave the manual controller 3 without operating it to set the currently displayed value, and thus the user's feeling of use can be improved.

(4) In the work vehicle according to (2) or (3), the controller may be configured or programmed to shift a display of the display device from a first screen displaying a current value of the predetermined value to a second screen displaying one default value of the plurality of default values on the display device in response to the pressing operation being performed for a first time, and shift the display on the display device from the second screen to the first screen without waiting for an operation of the manual controller after determining the predetermined value to be the default value being displayed on the display device.

After the predetermined value is determined to be the default value being displayed, the screen returns to the first screen without requiring the user's operation, so that the user's operation can be made simpler.

(5) In the work vehicle according to any one of (2) to (4), the controller may be configured or programmed to determine the predetermined value to be the default value being displayed on the display device before the waiting time elapses in a case where a predetermined operation is performed on the manual controller after the pressing operation is performed and before the waiting time elapses.

With this configuration, the predetermined value can be determined to be the default value being displayed without waiting the waiting time to leave the manual controller 3 without operating it, so that the user's feeling of use can be improved.

(6) In the work vehicle according to (1), the controller may be configured or programmed to cause the display device to sequentially display one default value among the plurality of default values in response to the pressing operation of pressing and releasing the push button within a predetermined pressing time, and determine the predetermined value to be the default value being displayed on the display device in response to a long press operation of pressing the push button for a time longer than the predetermined pressing time or a double click operation of pressing the push button a plurality of times within a predetermined time.

As a result, the default value can be selected and determined only by the pressing operation of one push button without combining with the rotation operation. As a result, the user's operation can be easier.

(7) In the work vehicle according to any one of (1) to (6), the manual controller may include a dial to receive a rotation operation, and the controller may be configured or programmed to adjust at least one default value of the plurality of default values according to the rotation operation.

With this configuration, the user can adjust the default values to any values. As a result, the “plurality of default values that are preset” can include a default value desired by a user.

(8) In the work vehicle according to any one of (1) to (7), the controller may be configured or programmed to sequentially display one of the plurality of default values on the display device according to a preset display order, according to the number of times that the pressing operation was performed.

With this configuration, a plurality of default values are displayed one by one on the display device in a preset display order in response to each pressing operation by a user, so that the user can easily grasp the default value currently being selected, and the user's feeling of use can be improved.

(9) In the work vehicle according to any one of (1) to (8), when sequentially displaying one of the plurality of default values on the display device according to the number of times that the pressing operation was performed, the controller may be configured or programmed to first display the default value determined as the predetermined value in the previous determination.

As the work by the work vehicle, the same work is usually continued. The controller is configured or programmed to first display the default value set in the previous determination on the display device, so that the user can reach the screen including the default value by one pressing operation. Therefore, a user can select a desired default value by a simpler operation.

(10) In the work vehicle according to any one of (1) to (9), the controller may be configured or programmed to cause name information to be displayed together with the default value when sequentially displaying one default value among the plurality of default values on the display device, and the name information may be information related to a work name or a state name of the work vehicle.

Since the name information is displayed together with the default value, a user can select a value suitable for the work the user wants to do based on the name information. Therefore, the user does not need to memorize values suitable for various works in advance. This can improve the user's feeling of use.

Hereinafter, example embodiments of the present disclosure will be described in detail with reference to the drawings.

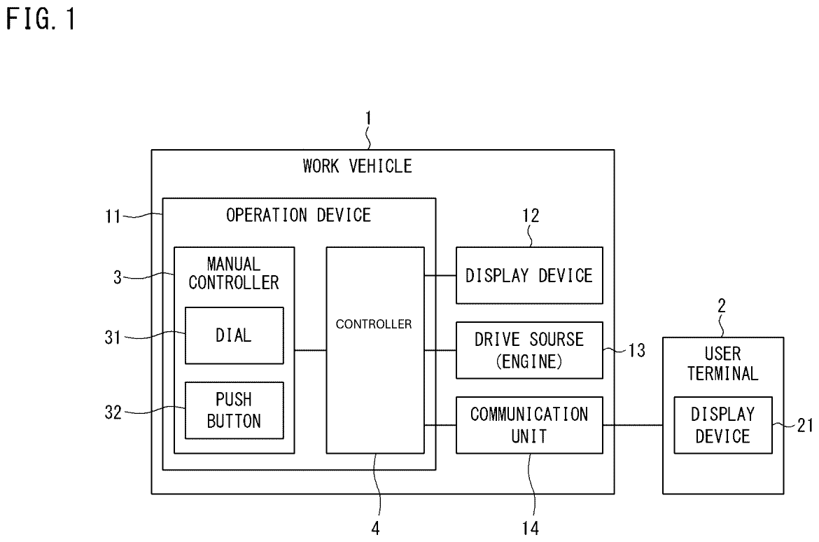

FIG. 1 is a block diagram illustrating a functional configuration of a work vehicle 1 according to an example embodiment.

The work vehicle 1 is a vehicle that operates an implement by a drive source 13, and is, for example, a tractor to which an agricultural implement or the like is attached. Specifically, the work vehicle 1 is a small tractor of an entry model (for beginners) designed for a user who operates a tractor for the first time, in which various operation commands are simplified, so that the user can easily use the work vehicle 1. The type of the work vehicle 1 is not particularly limited, and may be a construction work vehicle on which a construction implement such as a crane is attached, in addition to a farmwork vehicle.

A user terminal 2 is, for example, a terminal device managed or owned by a user, and is, for example, a smartphone, a tablet, a notebook computer, or a desktop computer. The user terminal 2 is provided separately from the work vehicle 1. The user terminal 2 includes a display device 21 such as a display. The display device 21 is an output interface that displays the state of the work vehicle 1 and various values to a user based on information transmitted from a communication unit 14 described below.

The work vehicle 1 includes an operation device 11, a display device 12, the drive source 13, and the communication unit 14. These units 11 to 14 are electrically connected, for example.

The operation device 11 is a device usable to select and determine predetermined values related to the operation of the work vehicle 1. The “predetermined values” include, for example, the rotation speed of the drive source 13, the hydraulic pressure of the implement, and the vehicle speed (traveling speed) of the work vehicle 1. In the following description, an example of setting the rotation speed of the drive source 13, as a representative example of the predetermined values, will be described. The operation device 11 includes a manual controller 3 to receive an operation from a user, and a controller 4 configured or programmed to control each unit of the work vehicle 1.

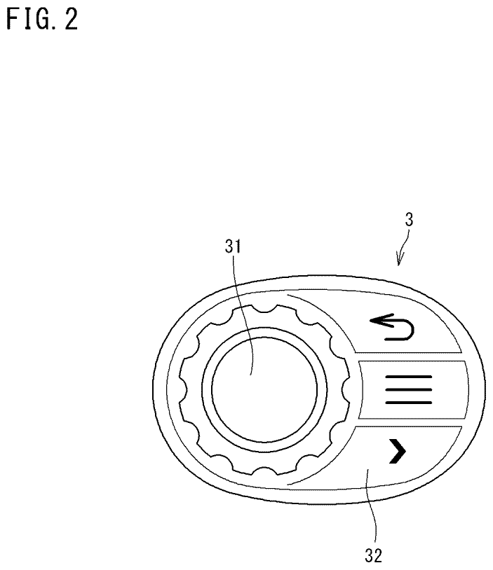

FIG. 2 is a schematic diagram illustrating the manual controller 3.

The manual controller 3 includes a dial 31 and a push button 32. The dial 31 is an input interface to receive a rotation operation performed by the user. When the dial 31 is rotated by a user, a pulse waveform having the low level and the high level is output to the controller 4 the number of times corresponding to the rotation angle.

The push button 32 is an input interface to receive a pressing operation by a user. The push button 32 is a momentary (self-restoring) button that emits an input signal only when pressed by a user. For example, the push button 32 outputs a low-level signal to the controller 4 when it is not pressed. When a user presses the push button 32 with his or her finger, the push button 32 is depressed in response to the pressing by the finger, and outputs a high-level signal to the controller 4. When the user releases the finger from the push button 32 after that, the depression of the push button 32 is automatically restored, and the push button 32 outputs a low-level signal to the controller 4 again.

The controller 4 is a computer device including a processor such as a central processing unit (CPU), a temporary storage memory (main memory) such as a random access memory (RAM), and a nonvolatile memory such as a read only memory (ROM), and is, for example, a micro controller unit (MCU). The controller 4 is configured or programmed to control each unit (for example, the display device 12, the drive source 13, and the communication unit 14) of the work vehicle 1 by causing a processor to perform various calculations and various types of processing in accordance with a computer program stored in a nonvolatile memory. Various types of control performed by the controller 4 will be described below.

The display device 12 is an output interface to display the state of the work vehicle 1 and predetermined values to a user according to the output of the controller 4. The display device 12 includes, for example, a monochrome or color liquid crystal display and a speaker. In addition to these, the display device 12 may include an indicator lamp including a light emitting diode (LED).

The drive source 13 is a rotary device to cause the work vehicle 1 to travel and drives an implement installed on the work vehicle 1. The drive source 13 is, for example, an engine that extracts power from combustion of combustion gas such as light oil or gasoline. The drive source 13 may be an electric motor that extracts power from electric energy.

The communication unit 14 is a communication interface to perform wireless communication with the user terminal 2. The communication unit 14 transmits various types of information to the user terminal 2, for example, according to the output of the controller 4. When receiving the information, the user terminal 2 displays the information on the display device 21. The communication unit 14 may directly communicate with the user terminal 2 by using a short-range wireless communication technology such as Bluetooth (registered trademark), or may communicate with the user terminal 2 by using a mobile communication technology via a base station.

In the following description, the controller 4 is configured or programmed to cause the display device 12 to display various screens. However, the controller 4 may be configured or programmed to cause the display device 21 to display various screens instead of or in addition to the display on the display device 12. That is, at least one of the display devices 12 or 21 functions as a “display device”.

Hereinafter, an issue to be solved by the work vehicle 1 will be described.

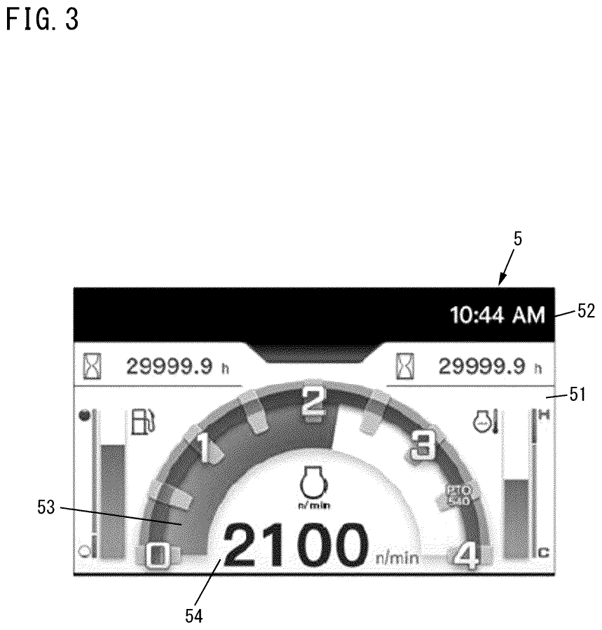

FIG. 3 is an example of a home screen 5 displayed on the display device 12.

The home screen 5 is an example of the “first screen”. When a user turns on the key switch of the work vehicle 1 to start the drive source 13, the controller 4 is configured or programmed to cause the display device 12 to display the home screen 5.

The home screen 5 includes a body 51 and a tab 52. The body 51 is an area in which main information is displayed to a user, and includes, for example, a first meter 53 indicating a current value of a predetermined value (such as the rotation speed of the drive source 13) in an arc shape, and a second meter 54 indicating the current value in a numerical value. The tab 52 is an area in which an icon for notifying a user of the current state of the work vehicle 1, warning information, or the like is displayed. The tab 52 may display the current time as in the example of FIG. 3.

When the key switch of the work vehicle 1 is turned on, the rotation speed of the drive source 13 is automatically set to the idling rotation speed by the controller 4. The idling rotation speed is, for example, 2100 r/min. When a user rotates the dial 31 clockwise while the home screen 5 is being displayed, the controller 4 increases the rotation speed of the drive source 13 according to the amount of the rotation operation (rotation angle).

When the power of the work vehicle 1 is used to work as a loader, the rotation speed of the drive source 13 is set to, for example, 3000 r/min. Alternatively, when the power of the work vehicle 1 is used for mowing or tilling, the rotation speed of the drive source 13 preferably is set to a relatively high value (for example, 3600 r/min). Therefore, when the work vehicle 1 is used for mowing or the like, after turning on the key switch, a user rotates the dial 31 until the current value 2100 r/min is adjusted to 3600 r/min. As described above, in a case where the rotation speed desired by the user is a value far from the idling rotation speed, there is a possibility that, for example, the dial 31 preferably is rotated many times, so that the operation may become troublesome for the user.

In order to solve this issue, the inventors have invented a method in which frequently used rotation speeds (for example, idling rotation speed, loader rotation speed, mowing rotation speed, and maximum rotation speed) among the rotation speeds of the drive source 13 are prepared in advance as default values, and the user is caused to select and determine the rotation speed with the dial 31 and the push button 32 in a state where the default values are displayed in arrangement on the display device 12.

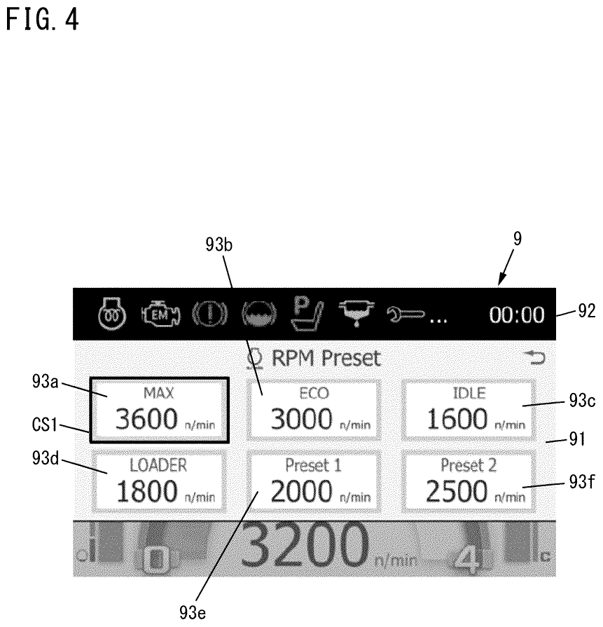

FIG. 4 is an example of a setting screen 9 displayed by the method. For example, when a user performs a pressing operation on the push button 32 while the home screen 5 is being displayed, the controller 4 causes the display device 12 to display the setting screen 9 in response to the pressing operation.

The setting screen 9 includes a body 91 and a tab 92. The body 91 is an area in which a plurality of default values 93a to 93f are displayed to the user, and is displayed, for example, in a state of being overlapped on the body 51 of the home screen 5 (pop-up state). Similarly to the tab 52 of the home screen 5, the tab 92 is an area in which icons for notifying a user of various types of information are displayed.

The plurality of default values 93a to 93f are values discretely set in advance for the rotation speed of the drive source 13, and are arranged and displayed in the body 91. For example, the default value 93a is the maximum rotation speed (which is also the mowing rotation speed) 3600 r/min, the default value 93b is the low output rotation speed (ECO mode rotation speed) 3000 r/min, the default value 93c is the idling rotation speed 1600 r/min, the default value 93d is the loader rotation speed 1800 r/min, the default value 93e is a first preset rotation speed 2000 r/min arbitrarily set by a user, and the default value 93f is a second preset rotation speed 2500 r/min arbitrarily set by a user. These six default values 93a to 93f are examples, and the default values and the number of default values may be other than these.

The body 91 includes a cursor CS1 that is displayed to overlap any one of the plurality of default values 93a to 93f. The cursor CS1 indicates a default value currently selected by a user, and is displayed as, for example, a frame of a predetermined color (red, yellow, or the like) surrounding the default value.

When a user rotates the dial 31 clockwise while the setting screen 9 is being displayed, the cursor CS1 moves in the order of the default values 93a, 93b, 93c, 93d, and 93e according to the rotation amount, then moves to the default value 93f, and then moves to the default value 93a. Then, when the user presses the push button 32 with the cursor CS1 overlapping a default value desired by the user, the controller 4 determines the rotation speed of the drive source 13 to be the default value and adjusts the rotation speed of the drive source 13 to the default value.

As described above, by using a method of displaying the plurality of default values 93a to 93f discretely set in advance on the display device 12, and allowing a user to select and determine a predetermined value from these default values 93a to 93f with the dial 31 and the push button 32, it is possible to avoid the operation of rotating the dial 31 many times as described above.

However, in this method, a user operates both the dial 31 and the push button 32. Since the dial 31 is operated by a rotation operation and the push button 32 is operated by a pressing operation, a combination of these different operations may make the operation rather troublesome. Therefore, the inventors have further devised the operation device 11 so that a predetermined value can be selected by a simpler operation. Hereinafter, an operation procedure in the present disclosure will be described.

In an operation procedure of an example embodiment of the present disclosure, only one push button 32 is used to select and determine a predetermined value (such as the rotation speed of drive source 13) without using the dial 31. Therefore, a user can select and determine a predetermined value by a simpler operation without combining the operations of the dial 31 and the push button 32.

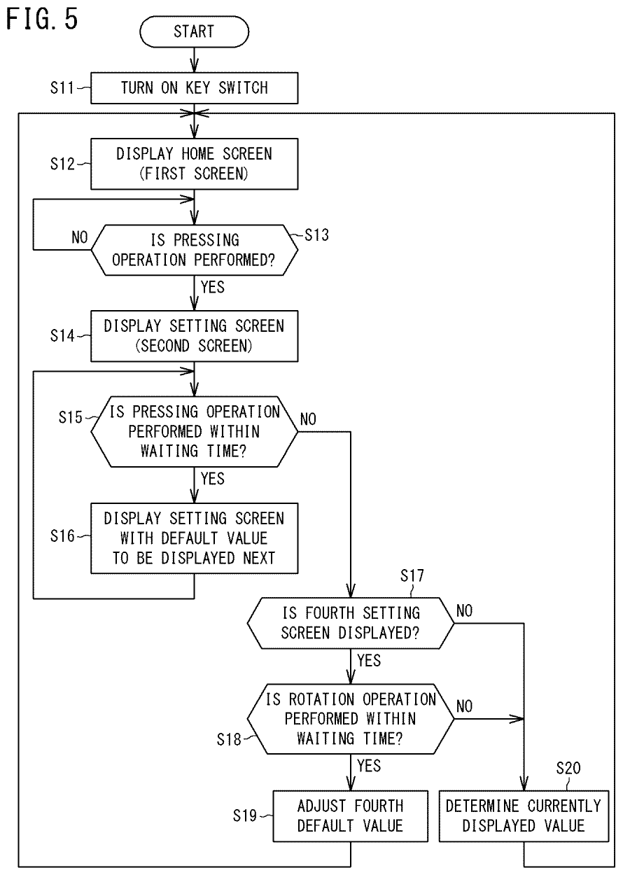

FIG. 5 is a flowchart illustrating processing performed by the operation device 11. Each step illustrated in FIG. 5 is realized by the controller 4 performing various calculations and various types of processing according to a computer program in response to a user's operation or the like.

In the operation device 11, discrete values of the predetermined value frequently used in the work vehicle 1 are set in advance as default values. These default values 64 are stored in advance in the memory or the like of the controller 4 before a selection and determination operation performed by the user.

For example, among the rotation speeds of the drive source 13, a mowing rotation speed 3600 r/min is stored as a first default value 64a, a loader rotation speed 3000 r/min is stored as a second default value 64b, and an idling rotation speed 2100 r/min is stored as a third default value 64c, in the memory of the controller 4. These default values 64a, 64b, and 64c are simply referred to as “default values 64” when they are not distinguished.

First, a user turns on a key switch of the work vehicle 1. As a result, the controller 4 detects that the key switch is turned on and starts the drive source 13 at the idling rotation speed (step S11).

Next, the controller 4 causes the display device 12 to display the home screen 5 (FIG. 3) (step S12). At the initial stage, since the rotation speed of the drive source 13 is the idling rotation speed, the idling rotation speed (for example, 2100 r/min) is displayed as the current value of the rotation speed on the first meter 53 and the second meter 54 of the home screen 5.

Next, the controller 4 determines whether a user has performed a pressing operation of the push button 32 while the home screen 5 is being displayed on the display device 12 (step S13). When the pressing operation of the push button 32 is not performed, the controller 4 continues receiving a pressing operation while displaying the home screen 5 on the display device 12 (NO in step S13).

When the pressing operation of the push button 32 is performed (YES in step S13), the controller 4 causes the display device 12 to display a setting screen 6 indicating one default value 64 out of the plurality of default values 64 (step S14). The setting screen 6 is an example of the “second screen”.

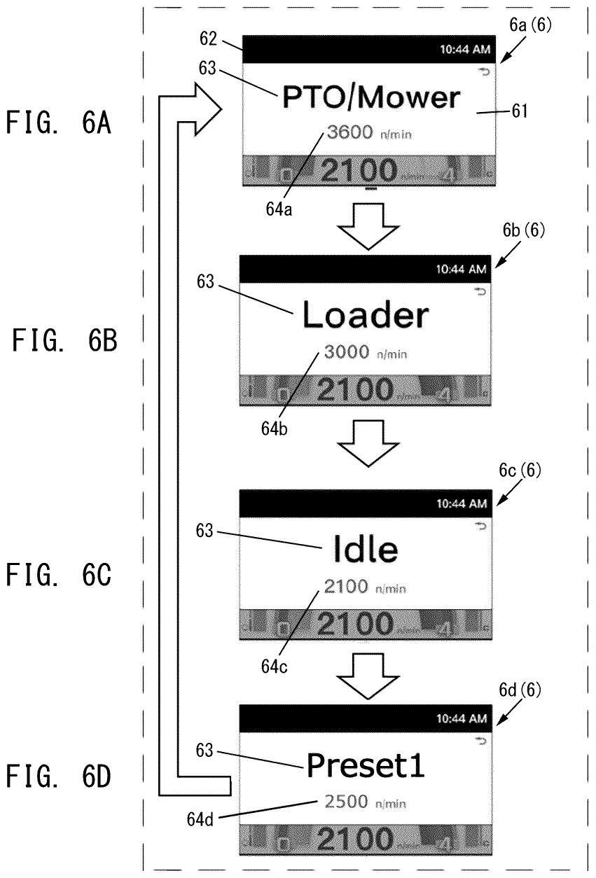

FIGS. 6A to 6D are schematic diagrams illustrating how setting screens 6 are sequentially displayed on the display device 12. The setting screen 6 is one of a first setting screen 6a including the first default value 64a as illustrated in FIG. 6A, a second setting screen 6b including the second default value 64b as illustrated in FIG. 6B, a third setting screen 6c including the third default value 64c as illustrated in FIG. 6C, and a fourth setting screen 6d including a fourth default value 64d as illustrated in FIG. 6D. These setting screens 6a, 6b, 6c, and 6d are simply referred to as “setting screens 6” when they are not distinguished.

On the display device 12, the plurality of default values are not displayed in arrangement as illustrated in FIG. 4, but only one default value 64 is displayed at a predetermined time point as illustrated in each of FIGS. 6A to 6D, so that a user can easily grasp the default value 64 currently being selected. As a result, the user's operation can be easier.

The setting screens 6 include a body 61 and a tab 62. The body 61 is an area in which one of the default values 64 and name information 63 corresponding to the default value 64 are displayed to a user, and is displayed, for example, in a state of being overlapped on the body 51 of the home screen 5 (pop-up state). The tab 62 is an area in which the same display as the tab 52 of the home screen 5 is performed.

The name information 63 is information displayed together with the default value 64, and is information about the work name of the work vehicle 1 or the state name of the work vehicle 1 performed with the default value 64. For example, on the first setting screen 6a, the work name of the work vehicle 1 “PTO/Mower” is displayed as the name information 63 together with the first default value 64a. On the second setting screen 6b, the second default value 64b and the work name of the work vehicle 1 “Loader” as the name information 63 are displayed, and on the third setting screen 6c, the third default value 64c and the state name of the work vehicle 1 “Idle” as the name information 63 are displayed.

For example, if the name information 63 is not displayed on the setting screen 6, it is necessary for a user to memorize the rotation speed and the like used for various works of the work vehicle 1 in advance, and to select and determine the default value 64 matching the rotation speed. As described above, it is difficult for a beginner user to memorize the rotation speeds suitable for various works of the work vehicle 1, and the operation can be troublesome. On the other hand, with the name information 63 displayed together with the default value 64, a user can select the rotation speed suitable for his/her desired work based on the name information 63, and thus, it is not necessary for the user to memorize the rotation speeds suitable for various works in advance. As a result, the user operation on the operation device 11 can be easier.

Here, on the fourth setting screen 6d, character information “Preset1” is displayed as the name information 63 together with the fourth default value 64d. The fourth default value 64d is a value that can be adjusted by a method to be described below, and is a so-called “user setting value” that is set to any value by a user. Therefore, the character information “Preset1” displayed on the fourth setting screen 6d can also be changed to any character information by a user by a method described below. As described above, for example, in addition to the default value 64 set in advance by the manufacturer of the work vehicle 1 before shipping the work vehicle 1, the default value 64 (for example, the fourth default value 64d) that is preset by a user after the work vehicle 1 is delivered to the user before the user performs various works may be displayed on the setting screen 6.

In the example of FIGS. 6A to 6D, the name information 63 is character information. However, the name information 63 is not limited thereto, and may be graphic information such as an illustration or a photograph. For example, an illustration of a state where a tractor is mowing may be displayed as graphic information on the first setting screen 6a instead of or together with the character information of “PTO/Mower” as the name information 63.

The display order of the plurality of setting screens 6 is preset and stored in the memory of the controller 4. For example, the display order is set such that the first setting screen 6a is displayed first, the second setting screen 6b is displayed second, the third setting screen 6c is displayed third, and the fourth setting screen 6d is displayed fourth. In the initial state, when the pressing operation of the push button 32 is performed, the controller 4 causes the display device 12 to display the first setting screen 6a set to be displayed first.

When there is the default value 64 determined by a user in the previous determination, the controller 4 stores the default value 64 in the memory, and displays the setting screen 6 including the default value 64 first in response to the first pressing operation performed by the user. For example, when a user has determined the second default value 64b as the rotation speed of the drive source 13 in the previous determination, the controller 4 displays the second setting screen 6b first according to the first pressing operation performed by the user. Thereafter, the controller 4 sequentially displays the third setting screen 6c second, the fourth setting screen 6d third, and the first setting screen 6a fourth, in response to the pressing operation.

As the work by the work vehicle 1, the same work is usually continued and, for example, the mowing work is performed in the morning, and the mowing work is performed again in the afternoon after a break. When displaying the setting screen 6 on the display device 12, the controller 4 first displays the default value 64 determined in the previous determination, so that the user can reach the setting screen 6 including the default value 64 by one pressing operation from the home screen 5. Therefore, the user can select the desired default value 64 by a simpler operation.

The controller 4 determines whether the pressing operation is performed for the second time after the pressing operation is performed for the first time in step S13 and before a predetermined waiting time T1 elapses (step S15). The waiting time T1 is, for example, 3 seconds or less, and is, specifically, about 1 to 2 seconds. The starting time of the waiting time T1 may be the time of the first pressing operation as described above, or may be the time when the controller 4 displays the first setting screen 6 on the display device 12.

In a case where there is almost no time lag between step S13 and step S14 (for example, in a case where the setting screen 6 is displayed within 0.5 seconds after the pressing operation), the starting time of the waiting time T1 may be either of the above timings. On the other hand, in a case where a time lag may occur between step S13 and step S14 (for example, in a case where the setting screen 6 is displayed for more than 0.5 seconds after the pressing operation), the starting time of the waiting time T1 is preferably the timing when the setting screen 6 is displayed on the display device 12. This is because the time during which the setting screen 6 is actually displayed to a user can be matched with the waiting time T1, so that the user's feeling of the waiting time T1 can be unified.

When the second pressing operation is performed within waiting time T1 (YES in step S15), the controller 4 causes the display device 12 to display the setting screen 6 to be displayed next (step S16). For example, when the first setting screen 6a is displayed in step S14 and the pressing operation is performed within the waiting time T1, the controller 4 displays the second setting screen 6b to be displayed next.

Similarly, when the second setting screen 6b is displayed in step S14 and the pressing operation is performed within the waiting time T1, the controller 4 displays the third setting screen 6c on the display device 12, and when the third setting screen 6c is displayed in step S14 and the pressing operation is performed within the waiting time T1, the controller 4 displays the fourth setting screen 6d on the display device 12. Thereafter, the controller 4 returns to the processing of step S15.

Therefore, when the user performs the pressing operation of the push button 32 a plurality of times at intervals within the waiting time T1, the controller 4 repeats steps S15 and S16 according to the number of times that the pressing operation was performed, and causes the display device 12 to sequentially display the default values 64 according to the preset display order.

For example, when the user presses the push button 32 twice at an interval within the waiting time T1 while the first setting screen 6a is being displayed in step S14, the second setting screen 6b is displayed on the display device 12 by the pressing operation for the first time, and then the third setting screen 6c is displayed by the pressing operation for the second time. In this manner, a user can reach the setting screen 6 that displays the desired default value 64 among the plurality of default values 64 from the home screen 5 only by the pressing operation of the push button 32.

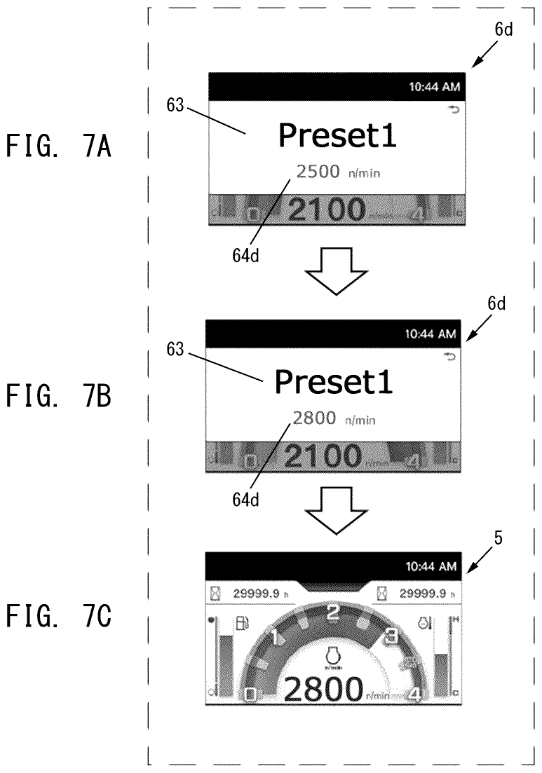

FIGS. 7A to 7C are schematic diagrams illustrating a state in which the default value 64 is adjusted according to the rotation operation.

In the present example embodiment, an example in which only the fourth default value 64d included in the fourth setting screen 6d is adjustable by a user will be described, but example embodiments of the present disclosure are not limited thereto, and for example, the first default value 64a and other values may be adjustable by a method similar to the method described below.

When a user performs a rotation operation of the dial 31 (YES in step S18) while the fourth setting screen 6d is displayed within the waiting time T1 (YES in step S17), the fourth default value 64d is adjusted according to the rotation operation, and after the adjustment, by leaving the manual controller 3 without performing a rotation operation on it, the predetermined value is determined as the fourth default value 64d after the adjustment (step S19).

For example, when a user rotates dial 31 clockwise while the fourth default value 64d (=2500 r/min) is being displayed on the fourth setting screen 6d as illustrated in FIG. 7A, the controller 4 increases the fourth default value 64d according to the rotation amount of the rotation operation as illustrated in FIG. 7B. Conversely, when a user rotates the dial 31 counterclockwise, the controller 4 decreases the fourth default value 64d according to the rotation amount of the rotation operation.

In a case where the default value 64 desired by a user is 2800 r/min, the user performs the rotation operation until the fourth default value 64d reaches 2800 r/min as illustrated in FIG. 7B, and stops the rotation operation when the desired value 2800 r/min is reached. After performing the rotation operation in step S18, in a case where the rotation operation is not performed for a predetermined waiting time T2 after the user stops the rotation operation, the controller 4 determines the fourth default value 64d as the value after adjustment and automatically shifts the display to the home screen 5 without waiting for the user's operation (that is, the processing returns to step S12).

As a result, a user can arbitrarily adjust the default value 64 by himself/herself in the middle of the operation of sequentially displaying the setting screens 6 (steps S14 to S16). Therefore, even when the default value 64 desired by the user is not in the plurality of default values 64, the user can determine the rotation speed to be the desired default value 64 by adjusting the default value 64 as desired by the rotation operation of the dial 31 and then leaving the manual controller 3 without operating it. This can improve the user's feeling of use.

Furthermore, the default value 64 once adjusted and determined in step S19 is stored in the memory of the controller 4. Then, when the pressing operation is performed (step S13) and the setting screens 6 are sequentially displayed (steps S14 to S16), the default value 64 adjusted and determined in step S19 performed for the previous determination is displayed as the fourth default value 64d included in the fourth setting screen 6d.

Note that the way of adjustment and determination of the default value 64 by the user's rotation operation is not limited to the above example, and for example, the default value 64 may be adjusted to any value by operating a menu button (not illustrated) in the manual controller 3 to display a screen usable to set the default value 64 and then performing the rotating operation of the dial 31 while the screen is displayed.

In a state where the setting screen 6 to display the default value 64 that is desired by a user is being displayed on the display device 12, the user leaves the manual controller 3 without operating it until the waiting time T1 elapses. As a result, the controller 4 determines that the next pressing operation has not been performed until the waiting time T1 elapses (NO in step S15), and in a case where the above-described rotation operation or the like has not been performed (NO in step S17 or step S18), the controller 4 determines the rotation speed of the drive source 13 to be the default value 64 currently displayed on the display device 12 (step S20).

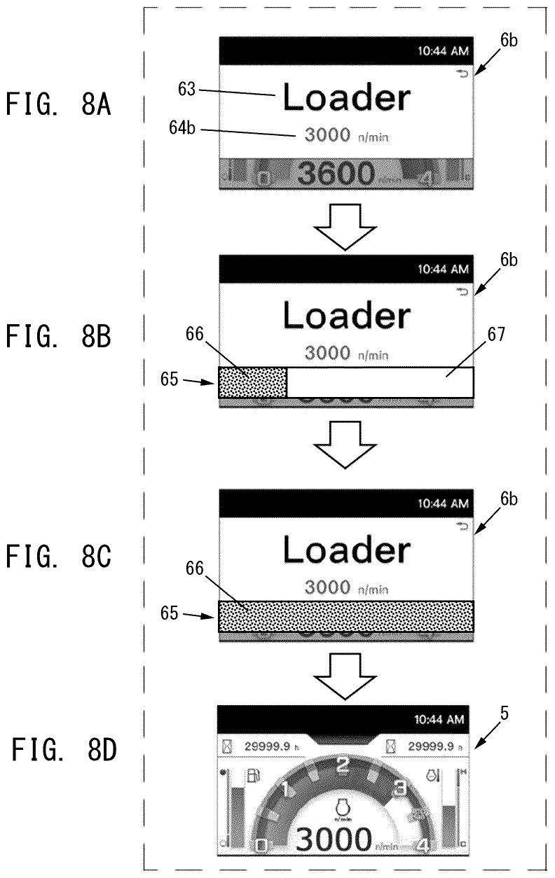

FIGS. 8A to 8D are schematic diagrams illustrating a state in which the predetermined value is determined to be the default value 64.

For example, in a case where a user desires the loader work, the user performs one or a plurality of pressing operations to make the second setting screen 6b including the second default value 64b displayed on the display device 12 as illustrated in FIG. 8A. In this state, the user leaves the manual controller 3 without operating it.

While the pressing operation is not performed, the controller 4 displays a seek bar 65 on the currently displayed second setting screen 6b as illustrated in FIG. 8B. The seek bar 65 is displayed, for example, in an area of the second setting screen 6b that does not overlap with the name information 63 or the second default value 64b.

The width of the seek bar 65 represents the waiting time T1. The seek bar 65 includes display of an elapsed time 66 from the previous pressing operation (the pressing operation detected in step S13 or step S14) to the current time and a remaining time 67 from the current time to the time when the waiting time T1 elapses. For example, as illustrated in FIGS. 8B and 8C, the elapsed time 66 is displayed as a bar extending from left to right with the lapse of time so as to fill the seek bar 65. The remaining time 67 is displayed as a margin area that is not filled with the elapsed time 66.

The elapsed time 66 and the remaining time 67 may be displayed in other expressions. For example, the elapsed time 66 and the remaining time 67 may be displayed in a “circular progress bar” commonly used as a loading animation. In addition, the elapsed time 66 and the remaining time 67 may be displayed as numerical values instead of a figure such as a bar or together with a figure such as a bar. Instead of displaying both the elapsed time 66 and the remaining time 67, only one of the elapsed time 66 and the remaining time 67 may be displayed.

As illustrated in FIG. 8C, the state in which the seek bar 65 is entirely filled with the elapsed time 66 means that the waiting time T1 has elapsed without performing the pressing operation since the previous pressing operation. Therefore, the controller 4 determines the predetermined value to be the second default value 64b currently displayed on the display device 12. Then, the controller 4 controls the drive source 13 to set the rotation speed of the drive source 13 to the determined value.

As described above, while the pressing operation is not performed, the controller 4 causes the display device 12 to display at least one of the elapsed time 66 or the remaining time 67 while the setting screen 6 is being displayed. As a result, the user can grasp how long a user needs to leave the manual controller 3 without operating it to determine the predetermined value to be the currently displayed value, by viewing these times 66 and 67, and thus, it is possible to improve the user's feeling of use.

Thereafter, as illustrated in FIG. 8D, the controller 4 automatically shifts the display of the display device 12 from the second setting screen 6b to the home screen 5 without waiting for an operation from the user. After the predetermined value is determined to be the default value 64 being displayed, the screen returns to the home screen 5 without requiring the user's operation, so that the user's operation can be made simpler.

According to the above operation procedure, the user can shift the display from the home screen 5 to the setting screen 6 only by the pressing operation of the push button 32, and can shift the display to the plurality of setting screens 6 according to the predetermined display order by further performing the pressing operation. Then, no pressing operation in a state where the desired default value 64 is being displayed on the display device 12 until the waiting time T1 elapses (that is, leaving the manual controller 3 without operating it) results in determination of the predetermined value to be the default value 64. Therefore, the user can select and determine a predetermined value by a simpler operation without combining the operations of the dial 31 and the push button 32.

Hereinafter, modifications of the example embodiment will be described. In the modifications, the same components as those in the above example embodiments are denoted by the same reference signs, and the description thereof will be omitted.

In the above-described example embodiments, in order to determine the predetermined value to be the default value 64 currently displayed, a user may leave the manual controller 3 without operating it. However, the operation of determining the default value 64 is not limited thereto, and the controller 4 may determine the predetermined value to be the default value 64 currently displayed in response to long press or double click of the push button 32.

For example, the controller 4 determines, in step S15, which one of a short press, a long press, and a double click is performed. Here, the short press means a pressing operation of pressing the push button 32 and releasing it within a predetermined pressing time T3 (for example, 1 second). The short press is synonymous with “short-time press”. Here, the long press means a pressing operation of pressing the push button 32 for a time longer than the predetermined pressing time T3 and releasing it. The long press is synonymous with “long-time press”. The double click means that the push button 32 is pressed a plurality of times (for example, twice) within a predetermined time T4.

When detecting the short press operation in step S15, the controller 4 proceeds to step S16 and displays the next default value 64 on the display device 12. On the other hand, when detecting the long press operation or the double click operation, the controller 4 proceeds to step S20 and determines the predetermined value to be the default value 64 currently displayed on the display device 12.

As a result, the default value 64 can be selected and determined only by the pressing operation of one push button 32 without combining with a rotation operation. As a result, the user's operation can be easier.

A user can also determine the predetermined value to be the default value 64 currently displayed on the display device 12 by “leaving” the manual controller 3 without operating it until the waiting time T1 elapses in step S15, similarly to the example embodiment. That is, a user can determine the predetermined value to be the default value 64 by “leaving” the manual controller 3 without operating it, or by performing a predetermined operation (for example, long press or double click described above) in a state where the desired default value 64 is being displayed on the display device 12.

In particular in the latter case, a user can determine the desired default value 64 before the waiting time T1 has elapsed (without waiting for it to elapse). As described above, in a case where the user desires to determine the default value 64 more quickly, the above-described method does not necessarily require waiting for the lapse of the waiting time T1, and thus the user's feeling of use can be improved.

Note that the “predetermined operation” is not particularly limited, and specifically, it can be any operation other than the short press, and may be an operation other than the long press or the double click described above. For example, the “predetermined operation” may be an operation of a button (not illustrated) other than the push button 32.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work vehicle that operates an implement by a drive source, the work vehicle comprising:
a manual controller including a push button to receive a pressing operation; and
a controller configured or programmed to determine a predetermined value from among a plurality of default values that are preset; wherein
the predetermined value is any one of a rotation speed of the drive source, a hydraulic pressure of the implement, and a vehicle speed of the work vehicle; and
the controller is configured or programmed to cause a display device to sequentially display one of the plurality of default values according to a number of times that the pressing operation was performed.

2. The work vehicle according to claim 1, wherein the controller is configured or programmed to:
determine the predetermined value to be the default value being displayed on the display device in a case where after the pressing operation is performed, the pressing operation is not performed again until a predetermined waiting time elapses; and
cause the display device to display a default value to be displayed next among the plurality of default values in a case where after the pressing operation is performed, the pressing operation is performed again before the waiting time elapses.

3. The work vehicle according to claim 2, wherein after the pressing operation is performed, the controller is configured or programmed to cause the display device to display at least one of an elapsed time from when the pressing operation is performed to a current time or a remaining time from the current time to a time when the waiting time elapses.

4. The work vehicle according to claim 2, wherein the controller is configured or programmed to: shift a display of the display device from a first screen displaying a current value of the predetermined value to a second screen displaying one default value of the plurality of default values on the display device in response to the pressing operation being performed for a first time; and
shift the display on the display device from the second screen to the first screen without waiting for an operation of the manual controller after determining the predetermined value to be the default value being displayed on the display device.

5. The work vehicle according to claim 2, wherein the controller is configured or programmed to determine the predetermined value to be the default value being displayed on the display device before the waiting time elapses in a case where a predetermined operation is performed on the manual controller after the pressing operation is performed and before the waiting time elapses.

6. The work vehicle according to claim 1, wherein the controller is configured or programmed to: cause the display device to sequentially display one default value among the plurality of default values in response to the pressing operation of pressing and releasing the push button within a predetermined pressing time; and
determine the predetermined value to be the default value being displayed on the display device in response to a long press operation of pressing the push button for a time longer than the predetermined pressing time or a double click operation of pressing the push button a plurality of times within a predetermined time.

7. The work vehicle according to claim 1, wherein
the manual controller includes a dial to receive a rotation operation; and
the controller is configured or programmed to adjust at least one default value of the plurality of default values according to the rotation operation.

8. The work vehicle according to claim 1, wherein the controller is configured or programmed to sequentially display one of the plurality of default values on the display device according to a preset display order, according to the number of times that the pressing operation was performed.

9. The work vehicle according to claim 1, wherein the controller is configured or programmed to first display the default value determined as the predetermined value in previous determination when sequentially displaying one of the plurality of default values on the display device, according to the number of times that the pressing operation was performed.

10. The work vehicle according to claim 1, wherein
the controller is configured or programmed to cause name information to be displayed together with the default value when sequentially displaying one default value among the plurality of default values on the display device; and
the name information is information related to a work name or a state name of the work vehicle.
